(19) United States
(12) Patent Application Publication
(10) Pub. No.: US 2025/0185120 A1
(43) Pub. Date: Jun. 5, 2025

(54) DELIVERY OF MULTICAST AND BROADCAST SERVICES

(71) Applicant: ZTE Corporation, Shenzhen (CN)

(72) Inventors: Yang LI, Shenzhen (CN); Tao QI, Shenzhen (CN); Lin CHEN, Shenzhen (CN)

(21) Appl. No.: 19/048,563

(22) Filed: Feb. 7, 2025

Related U.S. Application Data
(63) Continuation of application No. PCT/CN2022/110937, filed on Aug. 8, 2022.

(51) Int. Cl. H04W 76/40; H04L 12/18; H04W 76/22

(52) U.S. Cl. CPC H04W 76/40; H04L 12/189; H04W 76/22

(57) ABSTRACT

The present disclosure relates to a method for coordinating a Multicast and Broadcast Service, MBS, Radio Bearer, MRB, context of a multicast session between a central unit, CU, and a distributed unit, DU, comprising: receiving, by the DU, a first part of the MRB context from the CU, generating, by the DU based on a first configuration from the CU, a second part of the MRB context, and providing it to the CU.

### CROSS-REFERENCE TO RELATED APPLICATIONS

This application is a continuation of International Patent Application No. PCT/CN2022/110937, filed Aug. 8, 2022, the disclosure of which is incorporated herein by reference in its entirety.

### TECHNICAL FIELD

This document is directed generally to wireless communications, in particular to fifth generation (5G) wireless communications, and more particularly to a resource efficient delivery of MBS (multicast and broadcast services).

### BACKGROUND

The support of NR MBS (new radio multicast and broadcast services) was introduced to 5G systems (5GS) in Rel-17 of 3GPP. With that, 5GS is able to support Multicast and Broadcast Service, to enable efficient data delivery by utilizing the broadcast nature of wireless communication while delivery the data with reliability if needed.

This document relates to methods, systems, and devices for resource efficient delivery of Multicast and Broadcast Service, MBS.

### SUMMARY

The present disclosure relates to a method for coordinating a Multicast and Broadcast Service, MBS, Radio Bearer, MRB, context of a multicast session between a central unit, CU, and a distributed unit, DU, comprising:
receiving, by the DU, a first part of the MRB context from the CU,
generating, by the DU based on a first configuration from the CU, a second part of the MRB context, and
providing it to the CU.

Various embodiments may preferably implement the following features:

Preferably, the MRB context includes at least one of:
an MRB type, particularly point-to-point, PTP, only, or point-to-multipoint, PTM, only, or split MRB,
a radio link control, RLC, mode,
whether there is a per user equipment, UE, tunnel for one MRB for one specific UE, or
whether there is a shared tunnel for one MRB for a multicast session.

Preferably, in the first part the CU provides the MRB type, RLC mode, whether there is a per UE tunnel for one MRB for one specific UE, and/or whether there is a shared tunnel for one MRB for the multicast session.

Preferably, the DU allocates the corresponding resources for the MRB, including the RLC bearer for the MRB for the UE, and/or the per UE tunnel and provides the downlink tunnel info to the CU.

Preferably, the CU indicates the cell information associated with the PTM transmission with the MRB type that includes PTM transmission.

Preferably, the DU particularly allocates the resource based on the indication of the CU to allocate PTM resources for PTM transmission in the indicated cell for the UE.

Preferably, an association of the per UE MRB ID and the per session MRB index is indicated from the CU to the DU as part of the MRB context.

Preferably, the DU receives the indication of whether there will be a per UE tunnel for the MRB from the CU in the first part of the MRB context.

Preferably, the DU, based on the information available at DU side, determines at least one of
the MRB type, particularly point-to-point, PTP, only, or point-to-multipoint, PTM, only, or split MRB,
the radio link control, RLC, mode,
whether there is the per user equipment, UE, tunnel for one MRB for one specific UE, or
whether there is the shared tunnel for one MRB for the multicast session.

Preferably, if the indication of whether there will be a per UE tunnel for the MRB to the DU is true, the MRB type can be either PTP only or split MRB, and the RLC mode of the PTP entity is of RLC acknowledge, AM, mode.

Preferably, if the indication of whether there will be a per UE tunnel for the MRB to the DU is false, the MRB type can be either PTM only or split MRB, and the RLC mode of the PTP entity is of RLC unacknowledged, UM, mode.

Preferably, if the indication of whether there will be a per UE tunnel for the MRB to DU is false, the MRB type is determined by the DU.

Preferably, the DU determines all the MRB context for the MRB.

Preferably, the DU receives the RLC mode indication from the CU in the first part of the MRB context.

Preferably, the DU, based on the information available at the DU side, determines on the second part of the MRB context.

Preferably, the DU determines the MRB context based on the RLC mode as follows:
if the RLC mode is an acknowledge mode, AM, the MRB type can be either PTP only with one RLC entity of the AM, or split MRB, particularly with one RLC entity of the AM and one PTM RLC entity of unacknowledged mode, UM.

Preferably, the DU determines the MRB context based on the RLC mode as follows:
if the RLC mode is an unacknowledged mode, UM, the MRB type is based on the decision of the DU.

Preferably, the DU determines the MRB context based on the RLC mode as follows:
if the RLC mode is an unacknowledged mode the MRB type is of RLC UM, and the MRB type is determined by the DU, particularly by: determining the MRB type to be a PTP only type which comprises one RLC entity of the UM mode, or to be a split MRB which comprises one RLC entity of unacknowledged mode and one PTM RLC entity of the UM.

Preferably, the DU determines the MRB context based on the RLC mode indication as follows:
if the RLC mode indication is absent, the MRB type is based on the decision of the DU.

Preferably, the DU receives the RLC mode indication and indication of whether there will be a per UE tunnel for the MRB from the CU in the first part of the MRB context.

Preferably, the DU, based on the information available at DU side, determines on the second part of the MRB context.

Preferably, if the RLC mode is AM, and the indication of whether there will be a per UE tunnel for the MRB is true, the DU decides that the MRB type can be either PTP only with RLC AM mode RLC entity, or split MRB, particularly with one RLC AM mode PTP entity.

Preferably, if the RLC mode is AM, and the indication of whether there will be a per UE tunnel for the MRB is false, the DU decides that the MRB type can be either PTP only with RLC AM mode RLC entity, or split MRB, particularly with one RLC AM mode PTP entity.

Preferably, if the RLC mode is UM, and the indication of whether there will be a per UE tunnel for the MRB is true, the DU determines that the MRB type is a split MRB of an UM mode.

Preferably, if the RLC mode is UM, and the indication of whether there will be a per UE tunnel for the MRB is false, the DU determines that the MRB type is PTM only.

Preferably, for any option of the MRB context that is not indicated by the CU, the MRB context is determined by DU.

Preferably, for any option of the MRB context that is optionally not indicated by the CU the option of the MRB context is determined by DU.

Preferably, the indication of whether there is a per UE tunnel for one MRB for one specific UE is optionally not indicated by the CU, and the MRB type determined by the DU is PTM only.

Preferably, the MRB context including the RLC mode for the MRB is determined by the DU.

Preferably, after receiving the RLC mode of the MRB from the DU, the CU-control plane, CU-CP provides the RLC mode to the CU-user plane, CU-UP in a MRB context modification signaling.

Preferably, the MRB context that is optionally not determined by the CU is determined by the DU.

Preferably, information exchange between the CU and the DU is per UE signaling.

Preferably, information exchange between the CU and the DU is per multicast session signaling.

Preferably, the MRB context is for one specific MRB of associated MBS sessions, or for all MRBs of the associated MBS sessions.

The present disclosure further relates to a network node configured to coordinate Multicast and Broadcast Service, MBS, Radio Bearer, MRB, context of a multicast session between a central unit, CU, and the network node, comprising a processor configured to:
receive a first part of the MRB context from the CU,
generate, based on a first configuration from the CU, a second part of the MRB context, and
provide it to the CU.

Various embodiments may preferably implement the following features:

Preferably, the network node is a gNB-DU.

Preferably, the MRB context includes at least one of:
an MRB type, particularly point-to-point, PTP, only, or point-to-multipoint, PTM, only, or split MRB,
a radio link control, RLC, mode,
whether there is a per user equipment, UE, tunnel for one MRB for one specific UE, or
whether there is a shared tunnel for one MRB for a multicast session.

Preferably, in the first part the CU is configured to provide the MRB type, RLC mode, whether there is a per UE tunnel for one MRB for one specific UE, and/or whether there is a shared tunnel for one MRB for the multicast session.

Preferably, the processor is configured to allocate the corresponding resources for the MRB, including the RLC bearer for the MRB for the UE, and/or the per UE tunnel and provides the downlink tunnel info to the CU.

Preferably, the CU is configured to indicate the cell information associated with the PTM transmission with the MRB type that includes PTM transmission.

Preferably, the processor is configured to particularly allocate the resource based on the indication of the CU to allocate PTM resources for PTM transmission in the indicated cell for the UE.

Preferably, the CU is configured to indicate an association of the per UE MRB ID and the per session MRB index to the network node as part of the MRB context.

Preferably, the processor is configured to receive the indication of whether there will be a per UE tunnel for the MRB from the CU in the first part of the MRB context.

Preferably, the processor, based on the information available at the network node side, is configured to determine at least one of
the MRB type, particularly point-to-point, PTP, only, or point-to-multipoint, PTM, only, or split MRB,
the radio link control, RLC, mode,
whether there is the per user equipment, UE, tunnel for one MRB for one specific UE, or
whether there is the shared tunnel for one MRB for the multicast session.

Preferably, if the indication of whether there will be a per UE tunnel for the MRB to the network node is true, the MRB type can be either PTP only or split MRB, and the RLC mode of the PTP entity is of RLC acknowledge, AM, mode.

Preferably, if the indication of whether there will be a per UE tunnel for the MRB to the network node is false, the MRB type can be either PTM only or split MRB, and the RLC mode of the PTP entity is of RLC unacknowledged, UM, mode.

Preferably, if the indication of whether there will be a per UE tunnel for the MRB to the network node is false, the processor of the network node is configured to determine the MRB type.

Preferably, the processor is configured to determine all the MRB context for the MRB.

Preferably, the processor is configured to receive the RLC mode indication from the CU in the first part of the MRB context.

Preferably, the processor, based on the information available at the network node side, is configured to determine on the second part of the MRB context.

Preferably, the processor is configured to determine the MRB context based on the RLC mode as follows:
if the RLC mode is an acknowledge mode, AM, the MRB type can be either PTP only with one RLC entity of the AM, or split MRB, particularly with one RLC entity of the AM and one PTM RLC entity of unacknowledged mode, UM.

Preferably, the processor is configured to determine the MRB context based on the RLC mode as follows:
if the RLC mode is an unacknowledged mode, UM, the MRB type is based on the decision of the network node.

Preferably, the processor is configured to determine the MRB context based on the RLC mode as follows:
if the RLC mode is an unacknowledged mode the MRB type is of RLC UM, the MRB type is determined by the processor, particularly by: determining the MRB type to be a PTP only type which comprises one RLC entity of the UM mode, or to be a split MRB which comprises one RLC entity of unacknowledged mode and one PTM RLC entity of the UM.

Preferably, the processor is configured to determine the MRB context based on the RLC mode indication as follows:
if the RLC mode indication is absent, the MRB type is based on the decision of the network node.

Preferably, the processor is configured to receive the RLC mode indication and indication of whether there will be a per UE tunnel for the MRB from the CU in the first part of the MRB context.

Preferably, the processor, based on the information available at the network node side, determines on the second part of the MRB context.

Preferably, if the RLC mode is AM, and the indication of whether there will be a per UE tunnel for the MRB is true, the processor is configured to decide that the MRB type can be either PTP only with RLC AM mode RLC entity, or split MRB, particularly with one RLC AM mode PTP entity.

Preferably, if the RLC mode is AM, and the indication of whether there will be a per UE tunnel for the MRB is false, the processor is configured to decide that the MRB type can be either PTP only with RLC AM mode RLC entity, or split MRB, particularly with one RLC AM mode PTP entity.

Preferably, if the RLC mode is UM, and the indication of whether there will be a per UE tunnel for the MRB is true, the processor is configured to determine that the MRB type is a split MRB of an UM mode.

Preferably, if the RLC mode is UM, and the indication of whether there will be a per UE tunnel for the MRB is false, the processor is configured to determine that the MRB type is PTM only.

Preferably, for any option of the MRB context that is not indicated by the CU, the processor is configured to determine the MRB context.

Preferably, for any option of the MRB context that is optionally not indicated by the CU, the processor is configured to determine the option of the MRB context.

Preferably, the indication of whether there is a per UE tunnel for one MRB for one specific UE is optionally not indicated by the CU, and the processor is configured to determine the MRB type as PTM only.

Preferably, the processor is configured to determine the MRB context including the RLC mode for the MRB.

Preferably, after receiving the RLC mode of the MRB from the network node, the CU-control plane, CU-CP is configured to provide the RLC mode to the CU-user plane, CU-UP in a MRB context modification signaling.

Preferably, the processor is configured to determine the MRB context that is optionally not determined by the CU.

Preferably, the processor is configured to perform information exchange between the CU and the network node per UE signaling.

Preferably, the processor is configured to perform information exchange between the CU and the network node per multicast session signaling.

Preferably, the MRB context is for one specific MRB of associated MBS sessions, or for all MRBs of the associated MBS sessions.

The present disclosure further relates to a method for supporting efficient resource allocation for a multicast session in different status, comprising:
receiving, by a central unit user plane, CU-UP, indication from a central unit control plane, CU-CP, about a session activation and inactivation, and
allocating, by the CU-UP, a resource dynamically correspondingly.

Various embodiments may preferably implement the following features:

Preferably, the CU-UP receives indication from the CU-CP about the session inactivation.

Preferably, the CU-UP suspends a Multicast and Broadcast Service, MBS, Radio Barer, MRB, configuration.

Preferably, the CU-UP receives indication from the CU-CP about the session activation.

Preferably, the CU-UP resumes an MRB configuration.

Preferably, the CU-UP receives indication from the CU-CP about the session inactivation.

Preferably, the CU-UP releases an MRB configuration while a tunnel for the multicast session and a logic connection of a protocol are retained.

Preferably, the CU-UP releases an MRB configuration while a shared tunnel between the core network, particularly a 5G core network, 5GC, and a Radio Access Network, RAN, for the multicast session and a logic connection between the CU-CP and the CU-UP for the multicast session are retained.

Preferably, the tunnel is an NG-U tunnel. Preferably, the protocol is a E1AP protocol.

Preferably, the CU-UP receives an indication from the CU-CP about a multicast bearer context modification.

Preferably, the CU-UP releases an MRB configuration while the tunnel for the multicast session and a logic connection of the protocol are retained.

Preferably, the CU-UP receives an indication from the CU-CP about the session inactivation.

Preferably, the CU-UP allocates a tunnel for the multicast session and a logic connection of a protocol, while it does not allocate any MRB resources.

Preferably, the CU-UP receives an indication from the CU-CP about the session inactivation.

Preferably, the CU-UP allocates a tunnel for the multicast session and a logic connection of a protocol, while the allocated MRB are in a suspended status.

The present disclosure further relates to a network node configured to support efficient resource allocation for a multicast session in different status comprising a processor configured to:
receive from a central unit control plane, CU-CP, about a session activation and inactivation, and
allocate a resource dynamically correspondingly.

Various embodiments may preferably implement the following features:

Preferably, the network node is a gNB-CU-UP.

Preferably, the processor is configured to receive indication from the CU-CP about the session inactivation.

Preferably, the processor is configured to suspend a Multicast and Broadcast Service, MBS, Radio Barer, MRB, configuration.

Preferably, the processor is configured to receive indication from the CU-CP about the session activation.

Preferably, the processor is configured to resume an MRB configuration.

Preferably, the processor is configured to receive indication from the CU-CP about the session inactivation.

Preferably, the processor is configured to release an MRB configuration while a tunnel for the multicast session and a logic connection of a protocol are retained.

Preferably, the processor is configured to release an MRB configuration to release an MRB configuration while a shared tunnel between the core network, particularly a 5G core network, 5GC, and a Radio Access Network, RAN, for the multicast session and a logic connection between the CU-CP and a central unit user plane, CU-UP, for the multicast session are retained.

Preferably, the tunnel is an NG-U tunnel. Preferably, the protocol is a ElAP protocol.

Preferably, the processor is configured to receive an indication from the CU-CP about a multicast bearer context modification.

Preferably, the processor is configured to release an MRB configuration while the tunnel for the multicast session and a logic connection of the protocol are retained.

Preferably, the processor is configured to receive an indication from the CU-CP about the session inactivation.

Preferably, the processor is configured to allocate a tunnel for the multicast session and a logic connection of a protocol, while it does not allocate any MRB resources.

Preferably, the processor is configured to receive an indication from the CU-CP about the session inactivation.

Preferably, the processor is configured to allocate a tunnel for the multicast session and a logic connection of a protocol, while the allocated MRB are in a suspended status.

The present disclosure further relates to a method for supporting efficient resource allocation for multicast session in different status, comprising:
receiving, by a distributed unit, DU, indication from a central unit, CU, about a session activation and inactivation, and
allocating, by the DU, resource dynamically correspondingly.

Various embodiments may preferably implement the following features:

Preferably, the DU is notified by the CU about the inactivation operation and preferably, the DU suspends a Multicast and Broadcast Service, MBS, Radio Bearer, MRB, configuration, and also a lower layer configuration, and stops a multicast transmission, wherein particularly a F1-U interface is suspended and meanwhile the configuration is retained.

Preferably, the DU is notified by the CU about the activation operation, and preferably, the DU resumes a multicast configuration and resumes a multicast transmission.

Preferably, the DU is notified by the CU about the inactivation operation, and preferably, the DU releases a MRB and a lower layer configuration for the multicast, and preferably, the DU retains a user equipment, UE, join information.

Preferably, the DU is notified by the CU about a session status in a multicast context management signaling, and, if the session status is inactive, the DU responds to a context setup or modification request, but does not allocate resources for an MRB until the DU is notified that the session status is active by the CU.

The present disclosure further relates to a network node configured to support efficient resource allocation for multicast session in different status, comprising a processor configured to:
receive indication from a central unit CU about a session activation and inactivation, and
allocate resource dynamically correspondingly.

Various embodiments may preferably implement the following features.

Preferably, the network node is a gNB-DU.

Preferably, the processor is configured to be notified by the CU about the inactivation operation, and preferably, the processor is configured to suspend a Multicast and Broadcast Service, MBS, Radio Bearer, MRB, configuration, and also a lower layer configuration, and stops a multicast transmission, and the processor is particularly configured to suspend a F1-U interface and to meanwhile retain the configuration.

Preferably, the processor is configured to be notified by the CU about the activation operation, and preferably, the processor is configured to resume a multicast configuration and to resume a multicast transmission.

Preferably, the processor is configured to be notified by the CU about the inactivation operation, and preferably the processor is configured to release a MRB and a lower layer configuration for the multicast, and preferably the processor is configured to retain a user equipment, UE, join information.

Preferably, the processor is configured to be notified by the CU about a session status in a multicast context management signaling, and, if the session status is inactive, the processor is configured to respond to a context setup or modification request, but is further configured not to allocate resources for an MRB until the network node is notified that the session status is active by the CU.

The present disclosure relates to a computer program product comprising a computer-readable program medium code stored thereupon, the code, when executed by a processor, causing the processor to implement a wireless communication method recited in any one of the foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a schematic diagram of a wireless terminal according to an embodiment of the present disclosure.

FIG. 2 shows an example of a schematic diagram of a wireless network node according to an embodiment of the present disclosure.

FIGS. 3 to 5 show flowcharts of methods according to some embodiments of the present disclosure.

### DETAILED DESCRIPTION

For multicast, there are two defined states, i.e., active states, and inactive states:
Active state: Multicast MBS session is established and MBS data can be transmitted to the UEs that have joined the Multicast MBS session. Radio resources for the Multicast MBS session are established. To receive multicast MBS session data, user equipments, UEs, that joined the Multicast MBS session shall be in Connection Management, CM, -CONNECTED state for receiving data of the Multicast MBS session. UEs are allowed to join the Multicast MBS session (subject to authorization check). 5GC (5G Core (Network)) resources and radio resources for the Multicast MBS session are reserved for UEs that joined the Multicast MBS session.
Inactive state: Multicast MBS session is established but no MBS data is transmitted to the UEs that have joined the Multicast MBS session. Radio resources for the Multicast MBS session are released, and the UEs that joined the Multicast MBS session may be in CM-CONNECTED or CM-IDLE state. UEs are allowed to join the Multicast MBS session (subject to authorization check).

The session state is reflected in Radio Access Network, RAN, resource allocation:
Radio resources for the Multicast MBS session are released,
UEs that joined the Multicast MBS session may be in CM-CONNECTED or CM-IDLE state (therefore in RRC_IDLE),
When the multicast MBS session is inactive, if there is at least one UE joining the multicast MBS session is in RRC-CONNECTED state in the NG-RAN, the shared delivery from 5GC to RAN is not released.

The session state can also be defined as session status. These two terms might be used interchangeably in this document.

The support of NR MBS was introduced to 5G systems (5GS) in Rel-17 of 3GPP. With that, 5GS is able to support Multicast and Broadcast Service, to enable efficient data delivery by utilizing the broadcast nature of wireless communication while delivery the data with reliability if needed. In this disclosure, the issues of resource allocation inside RAN, especially from the network interfaces perspective, are addressed. Solutions on F1, E1 and NG interfaces are topics to be discussed.

A user equipment, UE, may be referred to as a node.

In this disclosure, a few aspects on the resource allocation mechanism for MBS especially multicast, on network interfaces, are discussed. Particularly:
on general resource allocation on NGAP design,
on F1AP (e.g, resource coordination for the MRB (MBS radio bearer)) for UE that joins multicast session between gNB-CU and gNB-DU)//gNB-CU might be referred as CU and gNB-DU might be referred as DU,
on E1AP (e.g, resource coordination for the MRB for UE that joins multicast session between gNB-CU-CP and gNB-CU-UP)//gNB-CU-UP might be referred as CP and gNB-CU-UP might be referred as UP,
in case of multicast session activation and deactivation.

### MRB Configuration Decision Inside RAN

For a multicast session, the gNB may use a RRC Reconfiguration message to configure or reconfigure a multicast MRB, e.g., add/release/modify the MRB's RLC entities. In order to minimize the data loss due to MRB reconfiguration, the gNB may configure UE to send a PDCP status report during reconfiguration which results in MRB type change.

In case of a CU/DU separate deployment, the MRB context needs to be coordinated between CU and DU to finalize the MRB context which will be partly configured to the UE in the Uu interface.

To determine the MRB context, some kind of coordination is needed. One MRB context might include:
the MRB type, i.e., PTP only, or PTM only, or split MRB. Such MRB type will be elaborated below,
the RLC mode, whether it is AM or UM of the PTP RLC entity if there is any (the RLC mode will be elaborated below as in the MRB configuration for one specific UE),
whether there is a per UE tunnel for one MRB for one specific UE (such per UE tunnel can be used between CU and DU to transmit the per UE data per MRB, e.g., the re-transmission for one UE per MRB, the forwarded data during handover, or the control info like PDCP Status report),
whether there is a shared tunnel for one MRB for the multicast session.

For MRB type, gNB provides one or more of the following multicast MRB configuration(s) to the UE via dedicated RRC signalling:
1. Multicast MRB with DL (DownLink) only RLC-UM or bidirectional RLC-UM configuration for PTP transmission;
2. Multicast MRB with RLC-AM entity configuration for PTP transmission;
3. Multicast MRB with DL only RLC-UM entity for PTM transmission;
4. Multicast MRB with two RLC-UM entities, one DL only RLC-UM entity for PTP transmission and the other DL only RLC-UM entity for PTM transmission;
5. Multicast MRB with three RLC-UM entities, one DL RLC-UM entity and one UL RLC-UM entity for PTP transmission and the other DL only RLC-UM entity for PTM transmission;
6. Multicast MRB with two RLC entities, one RLC-AM entity for PTP transmission and the other DL only RLC-UM entity for PTM transmission.

The configuration is based on network decision based on the UE number associated with the multicast session, network resources, and session QoS etc.

Type 1 and 2 are of PTP type; type 3 is of PTM only type; type 4, 5 and 6 are of split MRB type in which there are both PTP and PTM type RLC entity associated with the MRB, in which the PTP type can be AL or UM, DL only or bi-directional.

Type 2, 6 are of AM mode, and type 1, 3, 4, 5 are of UM mode. In short, as long as there is one RLC AM mode entity associated with the MRB, the MRB can be called AM mode, otherwise UM mode.

The CU might initiate the multicast context setup request to the DU, and include all the needed information to fulfill the following requirements:
shared F1-U tunnel for one MRB;
per UE F1-U tunnel for UE specific data for one MRB;
per session MRB ID or MRB index that is used to identify the MRB for one specific multicast session (the multicast MRB might be identified by an MRB ID or MRB index; in the later description we will use MRB index to differentiate the MRB ID for one particular UE);
per UE MRB ID associated with the MRB for each UE, such per UE MRB ID is allocated uniquely in the per UE MRB ID space, such MRB ID is used by DU to associate the RLC bearer or RLC entity within the cell group configuration for one specific UE.

The DU needs to be aware of the association of the per UE MRB ID and the per session MRB index, therefore the association of the per UE MRB ID and the per session MRB index is indicated from CU to DU as part of the MRB context.

In a typical CU and DU coordination, e.g., multicast session context management procedure, the DU makes the decision based on the information provided by the CU, or vice versa, the CU makes the decision based on information provided by the DU.

In the following example embodiments, different coordination procedures are provided based on different design principles.

### Embodiment 1 (the CU Determines all)

In this embodiment, the CU determines all the MRB context of one multicast session.

That is, the CU provides all the MRB context including MRB type, RLC mode, whether there will be a per UE tunnel for the MRB, and whether there will be a per MRB shared tunnel for the MRB.

After reception of the info from the CU, the DU allocates the corresponding resources for such MRB, e.g., RLC bearers for the MRB for the UE or the session, if the resources at the DU allow so.

After the DU receives the indication of true on “whether there will be a per UE tunnel” for the MRB, the DU establishes a per UE tunnel and provides the downlink tunnel info to the CU. In case of not enough resources, the DU might refuse on such a per UE tunnel. Meanwhile, the DU might refuse on the establishment of any PTP type MRB for such UE or the PTP RLC entity in the split MRB.

In another embodiment, with the MRB type indication, the CU also indicates the cell (list) information associated with the PTM transmission for that MRB. The DU allocates the resource based on the CU's indication, e.g., if there is a PTM transmission in one cell configured for one UE (PTM only or split MRB), the DU allocates the PTM transmission based on the indication.

### Embodiment 2 (CU Provides the Per UE Transmission Indication)

In this embodiment, the CU provides the indication of “whether there will be an per UE tunnel for the MRB” to the DU, while the DU, based on the information available at the DU side, makes the final decision on other information of the MRB context, e.g., the MRB type, RLC mode, whether there is a per UE tunnel for one MRB for one specific UE, or whether there is a shared tunnel for one MRB for the multicast session. The DU then provides the above decision to the CU.

In one (sub-) embodiment, the DU allocates the resources or determines the MRB context based on the indication: if the indication of “whether there will be a per UE tunnel for the MRB” to the DU is true, the MRB type can be either PTP only or split MRB, and the RLC mode of the PTP entity is of RLC AM mode. In such a case, the DU follows the CU's suggestion or request to allocate at least one PTP RLC bearer for RLC AM mode, since the per UE tunnel's intention might be the data forwarding or PDCP level data recovery or even PDCP status report that are usually for RLC AM mode.

In one (sub-) embodiment, the DU allocates the resources or determine the MRB context based on the indication: if the indication of “whether there will be a per UE tunnel for the MRB” to the DU is false, the MRB type can be either PTM only or split MRB, and the RLC mode of the PTP entity is of RLC UM mode. In such a case, PTM AM mode of the PTP transmission is not needed.

In one (sub-) embodiment, the DU allocates the resources or determine the MRB context based on the indication: if the indication of “whether there will be a per UE tunnel for the MRB” to the DU is false, the MRB type is determined by the DU.

In one (sub) embodiment, the indication of “whether there will be a per UE tunnel for the MRB” to the DU is a suggestion from the CU. That is, the DU is able to overwrite such suggestion and make the final decision on the MRB context, regardless of the indication from the CU.

### Embodiment 3 (CU Provides the RLC Mode to DU)

In this embodiment, the design principle is to be aligned with legacy that RLC mode is determined by the CU; while for the MRB type, it is about the resource allocation for PTP or PTM transmission and lower layer configurations to the related UE. This is also aligned with the previous consensus that the DU shall decide which transmission method for one UE to use, as the DU is able to determine more precisely based on its observation on the radio resources what the CU might not be able to.

In this embodiment, the CU only provides the RLC mode to the DU, while the DU based on the information available at the DU side makes the final decision on all other information of the MRB context, e.g., the MRB type, whether there is a per UE tunnel for one MRB for one specific UE, or whether there is a shared tunnel for one MRB for the multicast session. The DU then provides the above decision to the CU.

In one (sub-) embodiment, the DU allocates the resources or determines the MRB context based on the RLC mode: if the RLC mode is the AM mode, the MRB type can be either PTP only with RLC AM mode RLC entity, or split MRB (with one RLC AM mode PTP entity and one RLC UM mode PTM entity). If the RLC mode is UM mode, the MRB type is based on the DU's decision. In one (sub-) embodiment, if the RLC mode is UM mode, the MRB type is also of UM mode, and the MRB type can be either PTP only with RLC UM mode RLC entity, or split MRB (with one RLC UM mode PTP entity and one RLC UM mode PTM entity).

In one (sub) embodiment, the RLC mode is not indicated from the CU, the DU determines the MRB context based on the DU's decision.

In one (sub) embodiment, if the UE number is low, and the QoS requirement is high, the DU might decide there will be no shared tunnel for one MRB for the multicast session, and for each UE for that MRB, there will be one per UE tunnel for the multicast session for the associated UE.

### Embodiment 4 (CU Provides the RLC Mode and Also the Per UE Transmission Indication)

In this embodiment, the CU provides both the RLC mode of the MRB for one UE and also the indication of per UE transmission. With that, the DU determines the rest of the MRB context, i.e., the MRB type, or whether there is a shared tunnel for one MRB for the multicast session. The DU then provides the above decision to the CU.

In one (sub-) embodiment, if the RLC mode is AM, and the indication of “whether there will be a per UE tunnel for the MRB” is true, the DU decides that the MRB type can be either PTP only with RLC AM mode RLC entity, or split MRB (with one RLC AM mode PTP entity). The DU might confirm the requirement of there will be a per UE tunnel for the MRB.

In one (sub-) embodiment, if the RLC mode is UM, and the indication of “whether there will be a per UE tunnel for the MRB” is true, the DU decides that the MRB type can be either PTP only with RLC UM mode RLC entity, or split MRB (with one RLC UM mode PTP entity). The DU might confirm the requirement of there will be a per UE tunnel for the MRB by providing an DL tunnel information for the per UE tunnel.

The DU allocates the resources or determines the MRB context based on the RLC mode:

If the RLC mode is AM mode, the MRB type can be either PTP only with RLC AM mode RLC entity, or split MRB (with one RLC AM mode PTP entity).

If the RLC mode is UM mode and the indication of “whether there will be a per UE tunnel for the MRB” is true, the MRB type is the split MRB of UM mode.

If the RLC mode is UM mode and the indication of “whether there will be a per UE tunnel for the MRB” is false, the MRB type is the PTM only.

### Embodiment 5 (for the Information that is not Indicated by the CU)

In one embodiment, for any option that is not indicated by the CU, the MRB context is determined by the DU. The DU then provides the above decision to the CU.

In one embodiment, for any option that is optionally not indicated by the CU, the MRB context is determined by the DU. The DU then provides the above decision to the CU.

In one embodiment, the CU optionally does not provide the indication of “whether there is a per UE tunnel for one MRB for one specific UE”, the MRB type determined by the DU shall be PTM only. The DU then provides the above decision to the CU.

### Embodiment 6 (DU Determines)

In this embodiment, the DU decides on the MRB contexts, including the MRB type, RLC mode, per UE tunnel for per UE transmission, and the shared tunnel per MRB. The DU determines based on the resources at the DU side, and session context including UE number, QoS requirement, and also available resources. The DU then provides the above decision to the CU.

In this embodiment, in the ElAP signaling from CP to UP on the MRB context management signaling, the RLC mode of one MRB for one specific UE or all concerned UE, is optional. This is different from the existing ElAP protocol that requires RLC mode of one radio bearer is mandatorily provided from gNB-CU-CP.

In this embodiment, in the F1AP signaling from DU to CU, RLC mode is determined by the DU and provided to the CU in the Multicast context related signaling, e.g., multicast context setup response signaling. After the DU determines the RLC mode for one MRB, CP modifies the MRB context on UP in later E1AP signaling.

The indication of “whether there will be a per UE tunnel for the MRB” to the DU can be an indication to request to setup a PTP tunnel for such UE, or the UL (UpLink) termination information of the PTP tunnel, e.g., the UL TEID (Tunnel Endpoint IDentifier) and or IP address.

The signaling between CU and DU can be per UE or per session.

In the per session signaling, the indication is per session indicated, e.g., for all MRB associated with the multicast session.

RAN Behaviour for Activation and Deactivation from 5GC

In case of activation and deactivation operation determined by 5GC, RAN needs to act accordingly based on the principle of below:
Radio resources for the Multicast MBS session are released, and the UEs that joined the Multicast MBS session may be in CM-CONNECTED or CM-IDLE state;
When the multicast MBS session is inactive, if there is at least one UE joining the multicast MBS session is in RRC-CONNECTED state in the NG-RAN, the shared delivery is not released.

Therefore, the CU needs to notify the DU and UP about the 5GC decision on activation and deactivation, and the DU or UP needs to act accordingly. The resources might be released or suspended based on different design principle.

In one example, the CU notifies the DU about the deactivation operation. The DU suspends the MRB configuration, and also the lower layer configuration, and stops the multicast transmission. The F1-U, per UE or shared for the MRB, are suspended meanwhile the configuration is retained.

In another example, the CU notifies the DU about the activation operation. The DU resumes all the multicast configuration and resumes the multicast transmission.

In one example, the CU notifies the DU about the deactivation operation. The DU releases the MRB and also lower layer configuration for the multicast, and the DU retains the UE join information.

In one example, the CP notifies the UP about the deactivation operation. The UP suspends the MRB configuration, while retaining the NG-U info allocated for such multicast session. Upon activation notified by the CP, the UP resumes the MRB configuration.

In one example, the CP notifies the UP about the deactivation operation. The UP releases the MRB configuration, while retaining the NG-U info allocated for such multicast session. Upon activation notified by the CP (e.g., multicast bearer context modification), the UP configures the MRB based on the new set of MRB required by CP. In one example, all MRB configuration is allowed to be released while retaining the NG-U and ElAP logical connection allocated for such multicast session.

### Unknown Session Status for E1AP

In some cases, for the NG-U tunnel that has not been established, e.g., the first time RAN establishes the multicast session context, RAN might not be aware of the session statues, however, the admission control for UE join in the PDU session resource setup or modification might require the network to allocate the DL NG-U tunnel for such multicast session. Therefore, the RAN might need to allocate resources for a multicast session that is in inactive status, which is sub-optimal. An indication (for example, session status) might be provided to the UP which then allocates the DL NG-U tunnel resources without allocating the MRB resources (e.g., the MRB configuration is provided, but in suspended status).

In one example, the CU notifies the DU about the multicast context, in which it includes an indication that the resource allocation for the multicast session is not needed. Therefore, the MBS context is still retained, including the MRB configuration, or F1AP logic connection is still retained. However, the corresponding radio resources are not really allocated, i.e., no transmission of the multicast is ongoing.

In one (sub-) example, the CU notifies the DU in which an indication is included to indicate that the resource allocation for the MRB is needed. Upon this notification, the radio resources are established, and the DU starts the multicast data transmission.

In one example, the CP notifies the UP about the MRB configuration, in which it includes an indication that the resource allocation for the MRB is not needed. Therefore, the E1AP logic connection and the NG-U for the multicast session are still allocated but the MRB configuration, including the protocol stack entities are not configured. In one (sub-) example, the CP notifies the UP in which an indication is included to indicate that the resource allocation for the MRB is needed. Upon this notification, the resource including the protocol stack entities are established.

In one example, the DU starts the distribution setup request to the CU to allocate the F1-U resources for such multicast session. After the CU is aware that the session is inactive, the CU might respond to the DU with distribution setup fail information with cause value of “inactive multicast session”. The DU might release the allocated radio resources for the multicast session. Or, the DU might suspend the radio resource configuration for the multicast session.

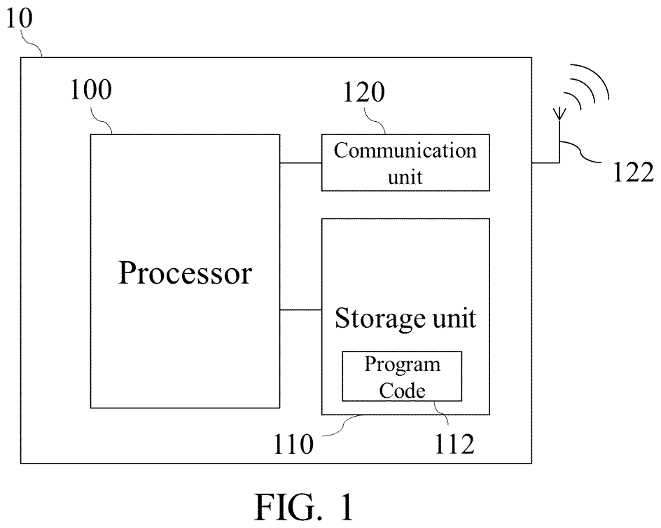

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g. messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g. a base station).

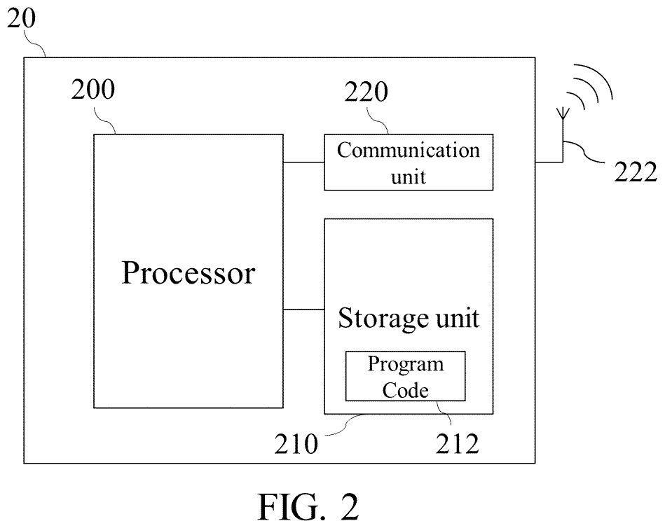

FIG. 2 relates to a schematic diagram of a wireless network node 20 according to an embodiment of the present disclosure. The wireless network node 20 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g. messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g. a user equipment or another wireless network node).

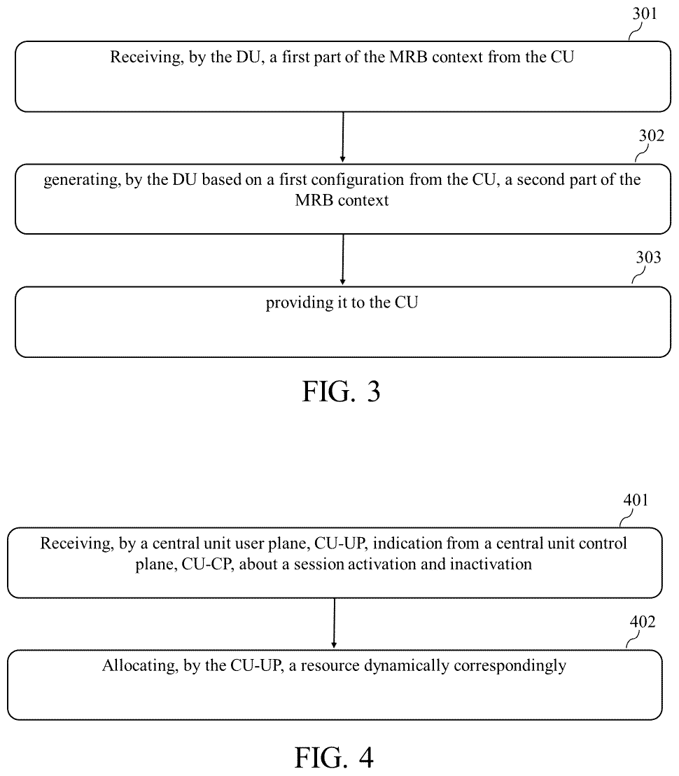

FIG. 3 shows a flowchart of a method according to an embodiment of the present disclosure. FIG. 3 relates to a method for coordinating a Multicast and Broadcast Service, MBS, Radio Bearer, MRB, context of a multicast session between a central unit, CU, and a distributed unit, DU. The method may be performed by a network node, particularly a gNB-DU, and comprises:
receiving 301, by the DU, a first part of the MRB context from the CU,
generating 302, by the DU based on a first configuration from the CU, a second part of the MRB context, and
providing 303 it to the CU.

In an embodiment, the MRB context includes at least one of:
an MRB type, particularly point-to-point, PTP, only, or point-to-multipoint, PTM, only, or split MRB,
a radio link control, RLC, mode,
whether there is a per user equipment, UE, tunnel for one MRB for one specific UE, or
whether there is a shared tunnel for one MRB for a multicast session.

In an embodiment, in the first part the CU provides the MRB type, RLC mode, whether there is a per UE tunnel for one MRB for one specific UE, and/or whether there is a shared tunnel for one MRB for the multicast session.

In an embodiment, the DU allocates the corresponding resources for the MRB, including the RLC bearer for the MRB for the UE, and/or the per UE tunnel and provides the downlink tunnel info to the CU.

In an embodiment, the CU indicates the cell information associated with the PTM transmission with the MRB type that includes PTM transmission.

In an embodiment, the DU particularly allocates the resource based on the indication of the CU to allocate PTM resources for PTM transmission in the indicated cell for the UE.

In an embodiment, an association of the per UE MRB ID and the per session MRB index is indicated from the CU to the DU as part of the MRB context.

In an embodiment, the DU receives the indication of whether there will be a per UE tunnel for the MRB from the CU in the first part of the MRB context.

In an embodiment, the DU, based on the information available at DU side, determines at least one of
the MRB type, particularly point-to-point, PTP, only, or point-to-multipoint, PTM, only, or split MRB,
the radio link control, RLC, mode,
whether there is the per user equipment, UE, tunnel for one MRB for one specific UE, or
whether there is the shared tunnel for one MRB for the multicast session.

In an embodiment, if the indication of whether there will be a per UE tunnel for the MRB to the DU is true, the MRB type can be either PTP only or split MRB, and the RLC mode of the PTP entity is of RLC acknowledge, AM, mode.

In an embodiment, if the indication of whether there will be a per UE tunnel for the MRB to the DU is false, the MRB type can be either PTM only or split MRB, and the RLC mode of the PTP entity is of RLC unacknowledged, UM, mode.

In an embodiment, if the indication of whether there will be a per UE tunnel for the MRB to DU is false, the MRB type is determined by the DU.

In an embodiment, the DU determines all the MRB context for the MRB.

In an embodiment, the DU receives the RLC mode indication from the CU in the first part of the MRB context

In an embodiment, the DU, based on the information available at the DU side, determines on the second part of the MRB context.

In an embodiment, the DU determines the MRB context based on the RLC mode as follows:
if the RLC mode is an acknowledge mode, AM, the MRB type can be either PTP only with one RLC entity of the AM, or split MRB, particularly with one RLC entity of the AM and one PTM RLC entity of unacknowledged mode, UM.

In an embodiment, the DU determines the MRB context based on the RLC mode as follows:
if the RLC mode is an unacknowledged mode, UM, the MRB type is based on the decision of the DU.

In an embodiment, the DU determines the MRB context based on the RLC mode as follows:
if the RLC mode is an unacknowledged mode the MRB type is of RLC UM, the MRB type is determined by the DU, particularly by: determining the MRB type to be a PTP only type which comprises one RLC entity of the UM mode, or to be a split MRB which comprises one RLC entity of unacknowledged mode and one PTM RLC entity of the UM.

In an embodiment, the DU determines the MRB context based on the RLC mode indication as follows:
if the RLC mode indication is absent, the MRB type is based on the decision of the DU.

In an embodiment, the DU receives the RLC mode indication and indication of whether there will be a per UE tunnel for the MRB from the CU in the first part of the MRB context.

In an embodiment, the DU, based on the information available at DU side, determines on the second part of the MRB context.

In an embodiment, if the RLC mode is AM, and the indication of whether there will be a per UE tunnel for the MRB is true, the DU decides that the MRB type can be either PTP only with RLC AM mode RLC entity, or split MRB, particularly with one RLC AM mode PTP entity.

In an embodiment, if the RLC mode is AM, and the indication of whether there will be a per UE tunnel for the MRB is false, the DU decides that the MRB type can be either PTP only with RLC AM mode RLC entity, or split MRB, particularly with one RLC AM mode PTP entity.

In an embodiment, if the RLC mode is UM, and the indication of whether there will be a per UE tunnel for the MRB is true, the DU determines that the MRB type is a split MRB of an UM mode.

In an embodiment, if the RLC mode is UM, and the indication of whether there will be a per UE tunnel for the MRB is false, the DU determines that the MRB type is PTM only.

In an embodiment, for any option of the MRB context that is not indicated by the CU, the MRB context is determined by DU.

In an embodiment, for any option of the MRB context that is optionally not indicated by the CU the option of the MRB context is determined by DU.

In an embodiment, the indication of whether there is a per UE tunnel for one MRB for one specific UE is optionally not indicated by the CU, and the MRB type determined by the DU is PTM only.

In an embodiment, the MRB context including the RLC mode for the MRB is determined by the DU.

In an embodiment, after receiving the RLC mode of the MRB from the DU, the CU-control plane, CU-CP provides the RLC mode to the CU-user plane, CU-UP in a MRB context modification signaling.

In an embodiment, the MRB context that is optionally not determined by the CU is determined by the DU.

In an embodiment, information exchange between the CU and the DU is per UE signaling.

In an embodiment, information exchange between the CU and the DU is per multicast session signaling.

In an embodiment, the MRB context is for one specific MRB of associated MBS sessions, or for all MRBs of the associated MBS sessions.

FIG. 4 shows a flowchart of a method according to an embodiment of the present disclosure. FIG. 4 shows a method for supporting efficient resource allocation for a multicast session in different status. The method may be performed by a network node, particularly a CU-UP, more particularly a gNB-CU-UP, and comprises:
receiving 401, by a central unit user plane, CU-UP, indication from a central unit control plane, CU-CP, about a session activation and inactivation, and
allocating 402, by the CU-UP, a resource dynamically correspondingly.

In an embodiment, the CU-UP receives indication from the CU-CP about the session inactivation.

In an embodiment, the CU-UP suspends a Multicast and Broadcast Service, MBS, Radio Barer, MRB, configuration.

In an embodiment, the CU-UP receives indication from the CU-CP about the session activation.

In an embodiment, the CU-UP resumes an MRB configuration.

In an embodiment, the CU-UP receives indication from the CU-CP about the session inactivation.

In an embodiment, the CU-UP releases an MRB configuration while a tunnel for the multicast session and a logic connection of a protocol are retained.

In an embodiment, the CU-UP releases an MRB configuration while a shared tunnel between the core network, particularly a 5G core network, 5GC, and a Radio Access Network, RAN, for the multicast session and a logic connection between the CU-CP and the CU-UP for the multicast session are retained.

In an embodiment, the tunnel is an NG-U tunnel. In an embodiment, the protocol is a E1AP protocol.

In an embodiment, the CU-UP receives an indication from the CU-CP about a multicast bearer context modification.

In an embodiment, the CU-UP releases an MRB configuration while the tunnel for the multicast session and a logic connection of the protocol are retained.

In an embodiment, the CU-UP releases an MRB configuration while a shared tunnel between the core network, particularly a 5G core network, 5GC, and a Radio Access Network, RAN, for the multicast session and a logic connection between the CU-CP and the CU-UP for the multicast session are retained.

In an embodiment, the CU-UP receives an indication from the CU-CP about the session inactivation.

In an embodiment, the CU-UP allocates a tunnel for the multicast session and a logic connection of a protocol, while it does not allocate any MRB resources.

In an embodiment, the CU-UP receives an indication from the CU-CP about the session inactivation.

In an embodiment, the CU-UP allocates a tunnel for the multicast session and a logic connection of a protocol, while the allocated MRB are in a suspended status.

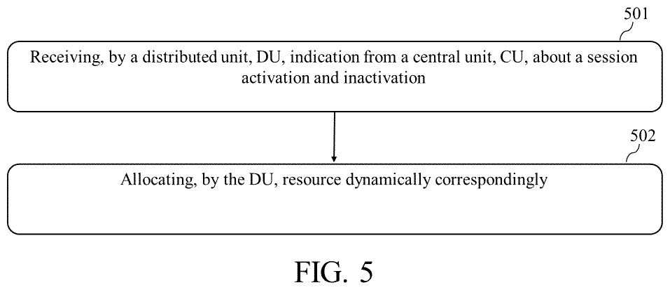

FIG. 5 shows a flowchart of a method according to an embodiment of the present disclosure. FIG. 5 shows a method for supporting efficient resource allocation for multicast session in different status. The method may be performed by a network node, particularly a DU, more particularly a gNB-DU, and comprises:
receiving 501, by a distributed unit, DU, indication from a central unit, CU, about a session activation and inactivation, and
allocating 502, by the DU, resource dynamically correspondingly.

In an embodiment, the DU is notified by the CU about the inactivation operation. In an embodiment, the DU suspends a Multicast and Broadcast Service, MBS, Radio Bearer, MRB, configuration, and also a lower layer configuration, and stops a multicast transmission, wherein particularly a F1-U interface is suspended and meanwhile the configuration is retained.

In an embodiment, the DU is notified by the CU about the activation operation. In an embodiment, the DU resumes a multicast configuration and resumes a multicast transmission.

In an embodiment, the DU is notified by the CU about the inactivation operation. In an embodiment, the DU releases a MRB and a lower layer configuration for the multicast. In an embodiment, the DU retains a user equipment, UE, join information.

In an embodiment, the DU is notified by the CU about a session status in a multicast context management signaling, and, if the session status is inactive, the DU responds to a context setup or modification request, but does not allocate resources for an MRB until the DU is notified that the session status is active by the CU.

The disclosure further relates to a computer program product comprising a computer-readable program medium code stored thereupon, the code, when executed by a processor, causing the processor to implement a wireless communication method as recited above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

### LIST OF ABBREVIATIONS

UE user equipment
DU distributed unit (gNB-DU)
CU central unit (gNB-CU)
CU-UP central unit user plane (gNB-CU-UP)
CU-CP central unit control plane (gNB-CU-CP)
E1AP E1 Application Protocol
F1AP F1 Application Protocol
MBS Multicast and Broadcast Service
MRB MBS radio bearer
NGU NGU tunnel
PTP point-to-point
PTM point-to-multipoint
RLC radio link control
AM acknowledge mode
UM unacknowledged mode

I/We claim:

1. A network node configured to coordinate Multicast and Broadcast Service, MBS, Radio Bearer, MRB, context of a multicast session between a central unit, CU, and the network node, comprising at least one processor configured to:
receive a first part of the MRB context from the CU,
generate, based on a first configuration from the CU, a second part of the MRB context, and
provide the second part to the CU.

2. The network node of claim 1, wherein the MRB context includes at least one of:
an MRB type, particularly point-to-point, PTP, only, or point-to-multipoint, PTM, only, or split MRB,
a radio link control, RLC, mode,
whether there is a per user equipment, UE, tunnel for one MRB for one specific UE, or
whether there is a shared tunnel for one MRB for a multicast session.

3. The network node of claim 2, wherein in the first part the CU is configured to provide the MRB type, RLC mode, whether there is a per UE tunnel for one MRB for one specific UE, and/or whether there is a shared tunnel for one MRB for the multicast session.

4. The network node of claim 3, wherein the at least one processor is configured to allocate corresponding resources for the MRB, including an RLC bearer for the MRB for the UE, and/or the per UE tunnel and provides a downlink tunnel info to the CU.

5. The network node of claim 3, wherein the CU is configured to indicate cell information associated with a PTM transmission with the MRB type that includes PTM transmission, and
wherein the processor is configured to particularly allocate a resource based on the indication of the CU to allocate PTM resources for PTM transmission in the indicated cell for the UE.

6. The network node of claim 1, wherein the CU is configured to indicate an association of per UE MRB ID and per session MRB index to the network node as part of the MRB context.

7. The network node of claim 2, wherein the at least one processor is configured to receive an indication of whether there will be a per UE tunnel for the MRB from the CU in the first part of the MRB context, and
wherein the at least one processor, based on information available at network node side, is configured to determine at least one of
the MRB type, particularly point-to-point, PTP, only, or point-to-multipoint, PTM, only, or split MRB,
the radio link control, RLC, mode,
whether there is the per user equipment, UE, tunnel for one MRB for one specific UE, or
whether there is the shared tunnel for one MRB for the multicast session.

8. The network node of claim 7, wherein if the indication of whether there will be a per UE tunnel for the MRB to the network node is true, the MRB type can be either PTP only or split MRB, and the RLC mode of PTP entity is of RLC acknowledge, AM, mode.

9. The network node of claim 7, wherein if the indication of whether there will be a per UE tunnel for the MRB to the network node is false, the MRB type can be either PTM only or split MRB, and the RLC mode of PTP entity is of RLC unacknowledged, UM, mode.

10. The network node of claim 7, wherein if the indication of whether there will be a per UE tunnel for the MRB to the network node is false, the processor of the network node is configured to determine the MRB type.

11. The network node of claim 7, wherein the at least one processor is configured to determine all the MRB context for the MRB.

12. The network node of claim 2, wherein the at least one processor is configured to receive an RLC mode indication from the CU in the first part of the MRB context, and
wherein the processor, based on information available at network node side, is configured to determine on the second part of the MRB context.

13. The network node of claim 12, wherein the at least one processor is configured to determine the MRB context based on the RLC mode as follows:
if the RLC mode is an acknowledge mode, AM, the MRB type can be either PTP only with one RLC entity of the AM, or split MRB, particularly with one RLC entity of the AM and one PTM RLC entity of unacknowledged mode, UM.

14. The network node of claim 12, wherein the at least one processor is configured to determine the MRB context based on the RLC mode as follows:
if the RLC mode is an unacknowledged mode, UM, the MRB type is based on a decision of the network node.

15. The network node of claim 12, wherein the at least one processor is configured to determine the MRB context based on the RLC mode as follows:
if the RLC mode is an unacknowledged mode the MRB type is of RLC UM, the MRB type is determined by the processor, particularly by: determining the MRB type to be a PTP only type which comprises one RLC entity of the UM mode, or to be a split MRB which comprises one RLC entity of unacknowledged mode and one PTM RLC entity of the UM.

16. The network node of claim 12, wherein the at least one processor is configured to determine the MRB context based on the RLC mode indication as follows:
if the RLC mode indication is absent, the MRB type is based on a decision of the network node.

17. The network node of claim 2, wherein the at least one processor is configured to receive an RLC mode indication and indication of whether there will be a per UE tunnel for the MRB from the CU in the first part of the MRB context, and
wherein the processor, based on information available at network node side, determines on the second part of the MRB context.

18. The network node of claim 17, wherein if the RLC mode is AM, and the indication of whether there will be a per UE tunnel for the MRB is true, the processor is configured to decide that the MRB type can be either PTP only with RLC AM mode RLC entity, or split MRB, particularly with one RLC AM mode PTP entity.

19. A network node configured to support efficient resource allocation for a multicast session in different status comprising at least one processor configured to:
receive from a central unit control plane, CU-CP, about a session activation and inactivation, and
allocate a resource dynamically correspondingly.

20. A network node configured to support efficient resource allocation for multicast session in different status, comprising at least one processor configured to:
receive indication from a central unit CU about a session activation and inactivation, and
allocate resource dynamically correspondingly.
